(19) United States
(12) Patent Application Publication
(10) Pub. No.: US 2019/0187839 A1
(43) Pub. Date: Jun. 20, 2019

(54) MODULAR WIRELESS WALL-MOUNTED SWITCH DEVICE

(71) Applicant: PHILIO TECHNOLOGY CORPORATION, NEW TAIPEI CITY (TW)

(72) Inventor: Cheng-Hung HUANG, NEW TAIPEI CITY (TW)

(21) Appl. No.: 16/282,837

(22) Filed: Feb. 22, 2019

Related U.S. Application Data
(63) Continuation-in-part of application No. 15/429,179, filed on Feb. 10, 2017.

(51) Int. Cl. G06F 3/044; G08C 17/02

(52) U.S. Cl. CPC G06F 3/044; G08C 17/02

(57) ABSTRACT

A modular wireless wall-mounted switch device includes a body having a plurality of switches and connecting ports, a control module including a microprocessor electrically connected with the switches and connecting ports of the body to correspond the witches to the respective connecting ports and a wireless signal transmitter electrically connected to the microprocessor, and a plurality of controllers each having stored therein an identification code corresponding to one respective electrical product and a control signal for controlling one respective electrical product. When the user triggers one switch, the microprocessor sends out the control signal and the respective identification code of the respective controller corresponding to the triggered switch through the wireless signal transmitter, causing the respective controller to control the operation of the respective electrical product.

### BACKGROUND OF THE INVENTION

### 1. Field of the Invention

The present invention relates to wireless wall control switch means and more particularly, to a modular wireless wall-mounted switch device, which allows change of controllers to control different electrical products in a wireless manner.

### 2. Description of the Related Art

For convenience use, the switches for controlling the electrical lights, ceiling fans, electric curtains and other electrical products that are used in a house or company are normally placed on the wall.

However, if there is no reserved pipeline on the line configuration for wall control switches, it will cause installation problems.

Furthermore, the wall-mounted switch designs provide multiple switch positions for installation and replacement of switches in a wired manner. These designs are not suitable for wirelessly controlled electrical products.

### SUMMARY OF THE INVENTION

The present invention has been accomplished under the circumstances in view. It is therefore the main object of the present invention to provide a modular wireless wall-mounted switch device, which allows installation of multiple controllers for controlling the operation of multiple electrical products in a wireless manner and allows change of controllers to control different electrical products in a cost-saving manner.

To achieve this and other objects of the present invention, a modular wireless wall-mounted switch device comprises a body, a control module and a plurality of controllers. The body comprises a plurality of switches and connecting ports. The control module comprises a microprocessor electrically connected with the switches and connecting ports of the body to correspond the switches to the respective connecting ports, and a wireless signal transmitter electrically connected to the microprocessor. The controllers each have stored therein an identification code corresponding to one respective electrical product and a control signal for controlling one respective electrical product. When the user triggers one switch, the microprocessor sends out the control signal and the respective identification code of the respective controller corresponding to the triggered switch through the wireless signal transmitter, causing the respective controller to control the operation of the respective electrical product.

Preferably, the microprocessor of the control module has built therein a control mode and a learning mode. The control mode controls the correspondence between the switches and the connecting ports. The learning mode is used to change the correspondence between the switches and the connecting ports.

Preferably, the body further comprises a substrate, and a front touch panel covered on a front side of the substrate. Further, the switches are mounted in the substrate in an array and covered by the front touch panel. Further, the connecting ports are arranged on an opposing back side of the substrate in an array. Further, the switches are capacitive switches to be triggered by the user by touching the front touch panel.

### BRIEF DESCRIPTION OF THE DRAWINGS

FIG. 1 is an oblique top elevational view of a modular wireless wall-mounted switch device in accordance with the present invention.

FIG. 2 corresponds to FIG. 1 when viewed from another angle.

FIG. 3 is an exploded view of the front touch panel and the substrate.

FIG. 4 is an exploded view of the back cover and the substrate.

FIG. 5 is a block diagram of the present invention.

### DETAILED DESCRIPTION OF THE PREFERRED EMBODIMENT

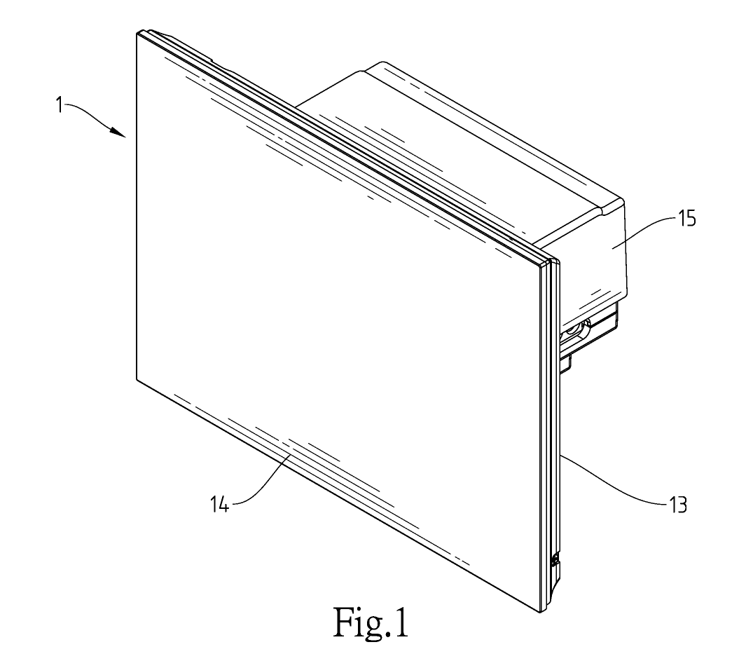

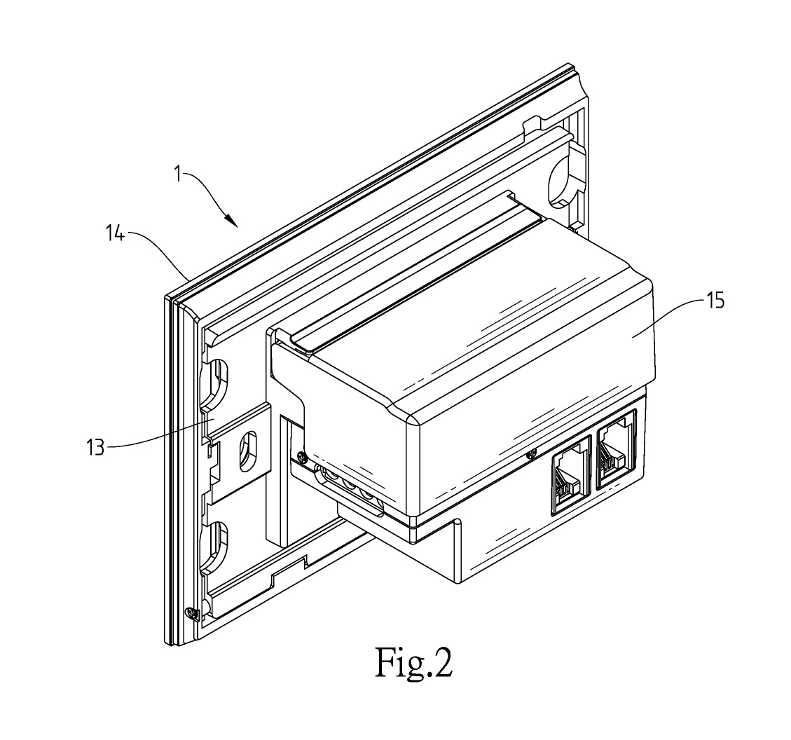

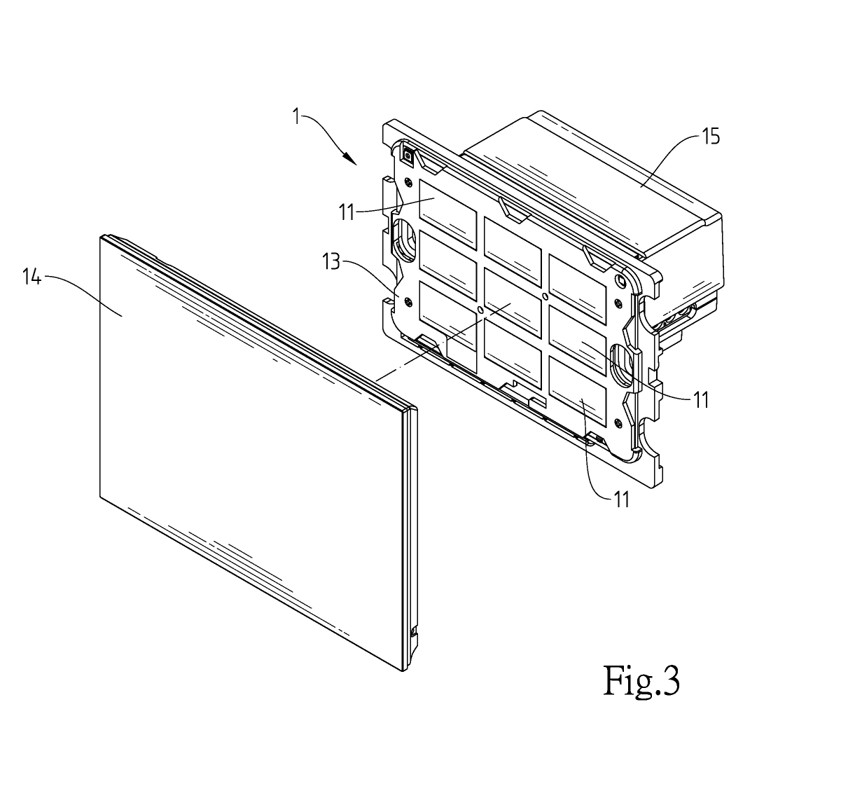

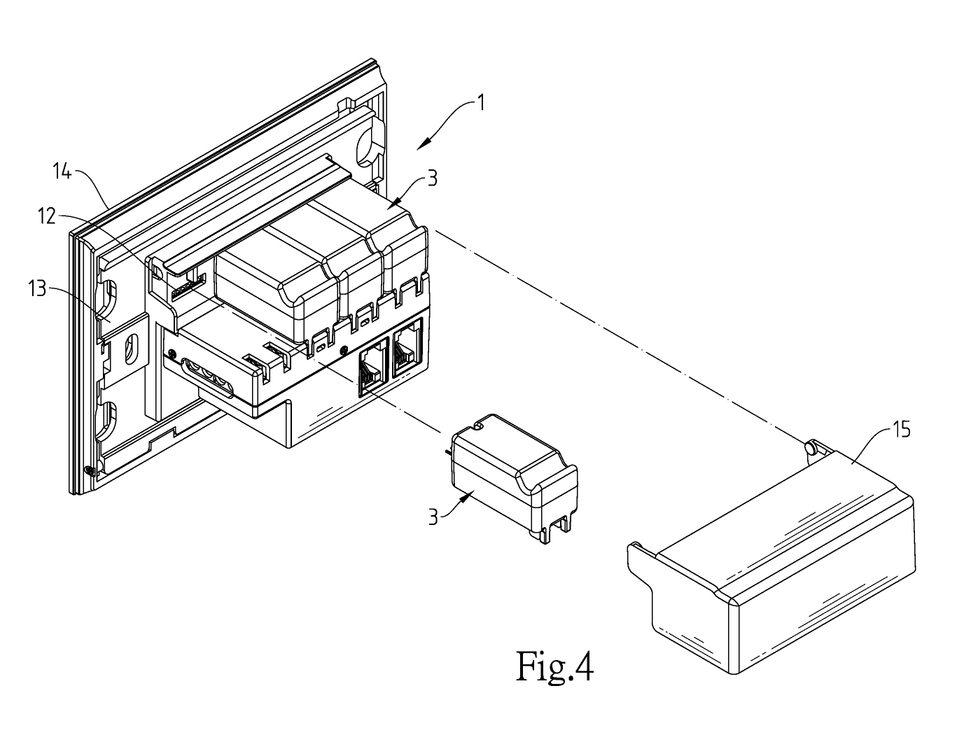

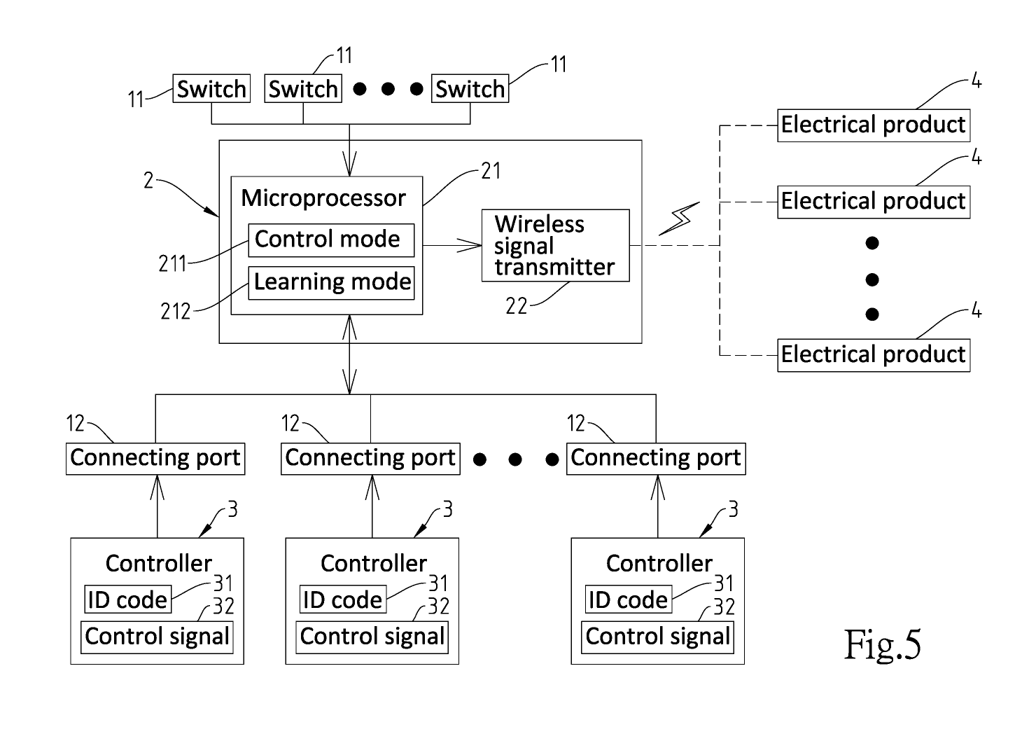

Referring to FIGS. 1-5, a modular wireless wall-mounted switch device in accordance with the present invention is shown. The modular wireless wall-mounted switch device comprises a body (1), a control module (2), and a plurality of controllers (3).

The body (1) comprises a plurality of switches (11), a plurality of connecting port (12), a substrate (13), a front touch panel (14) and a back cover (15). The substrate (13) is adapted for fixation to the wall. The front touch panel (14) is covered on a front side of the substrate (13). The switches (11) are mounted in the substrate (13) in an array. The connecting ports (12) are arranged in an array on an opposite back side of the substrate (13). The back cover (15) covers the connecting ports (12). The switches (11) are capacitive switches (11). The user can touch the front touch panel (14) to trigger switches (11).

The control module (2) comprises a microprocessor (21) and a wireless signal transmitter (22) electrically connected to the microprocessor (21). The microprocessor (21) has built therein a control mode (211) and a learning mode (212). The switches (11) and connecting ports (12) of the body (1) are electrically connected to the microprocessor (21). The control mode (211) controls the correspondence between the switches (11) and the connecting ports (12), so that each switch (11) corresponds to one respective connecting port (12). The learning mode (212) is used to change the correspondence between the switches (11) and the connecting ports (12) in control mode (211).

The controllers (3) each have stored therein an identification code (31) of one respective electrical product (4), and a respective control signal (32) for controlling one respective electrical product (4).

Thus, when the user touches the front touch panel (14) to trigger one switch (11) after connection of the controller (3) to the corresponding connecting port (12) of the body (1), the microprocessor (21) sends out the control signal (32) and the respective identification code (31) of the controller (3) corresponding to the triggered switch (11) through the wireless signal transmitter (22), enabling the controller (3) to control the respective electrical product (4) according to the correspondence between the switches (11) and the connecting ports (12) stored in the control mode (211). Further, the user can use the learning mode (212) to change the correspondence between the switches (11) and the connecting ports (12) according to personal preferences.

What the invention claimed is:

1. A modular wireless wall-mounted switch device installed in a wall for controlling the operation of a plurality of electrical products (4) in a wireless manner, comprising:
a body (1) comprising a plurality of switches (11) and a plurality of connecting ports (12);
a control module (2) comprising a microprocessor (21) and a wireless signal transmitter (22) electrically connected to said microprocessor (21), said microprocessor (21) being electrically connected with said switches (11) and said connecting ports (12) of said body (1) to correspond said switches (11) to the respective said connecting ports (12); and
a plurality of controllers (3) each having stored therein an identification code (31) corresponding to one respective said electrical product (4) and a control signal (32) for controlling one respective said electrical product (4);
when the user triggers one said switch (11) after connection of said controllers (3) to the respective said connecting ports (12) of said body (1), said microprocessor (21) sends out the control signal (32) and the respective identification code (31) of the respective said controller (3) corresponding to the triggered said switch (11) through said wireless signal transmitter (22), causing the respective said controller (3) to control the operation of the respective said electrical product (4).

2. The modular wireless wall-mounted switch device as claimed in claim 1, wherein said microprocessor (21) of said control module (2) has built therein a control mode (211) and a learning mode (212), said control mode (211) controlling the correspondence between said switches (11) and said connecting ports (12), said learning mode (212) being used to change the correspondence between said switches (11) and said connecting ports (12).

3. The modular wireless wall-mounted switch device as claimed in claim 1, wherein said body (1) comprises a substrate (13) and a front touch panel (14) covered on a front side of said substrate (13); said switches (11) are mounted in said substrate (13) in an array and covered by said front touch panel (14); said connecting ports (12) are arranged on an opposing back side of said substrate (13) in an array; said switches (11) are capacitive switches to be triggered by the user by touching said front touch panel (14).
